(19) United States
(12) Patent Application Publication
(10) Pub. No.: US 2006/0129826 A1
(43) Pub. Date: Jun. 15, 2006

(54) Electronic apparatus and method of reinforcing security thereof

(75) Inventor: Satoshi Azuchi, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/289,355

(22) Filed: Nov. 30, 2005

(30) Foreign Application Priority Data
Nov. 30, 2004 (JP) 2004-346797

(51) Int. Cl. H04L 9/00

(52) U.S. Cl. 713/176

(57) ABSTRACT

An electronic apparatus includes a main unit, a cover, openably attached to the main unit, for covering an operation unit arranged in the main unit, a lock mechanism for locking the cover to the main unit with the cover closed to the main unit, an input unit for inputting bio-information to the main unit with the cover closed to the main unit, an authentication unit for performing an authentication process in response to the bio-information input by the input unit, and a control unit for releasing the lock mechanism from the lock state thereof to unlock the cover from the main unit if the authentication process has been successfully completed.

### CROSS-REFERENCE TO RELATED APPLICATIONS

This application claims the benefit of priority of Japanese Patent Application No. 2004-346797, filed Nov. 30, 2004, the entire contents of which are incorporated herein by reference.

### BACKGROUND

1. Field

The present invention relates to an electronic apparatus and a method of reinforcing security of the electronic apparatus and, in particular, to an electronic apparatus and a method of reinforcing the security of the electronic apparatus using a lock mechanism.

2. Description of the Related Art

Many of electronic apparatuses including information processing apparatuses include a storage therein storing a variety of information. The storage typically stores information relating to privacy of individuals and corporate secret.

As electronic devices and memory devices are miniaturized and light-weighted in design, many mobile electronic apparatuses with a memory device having a large memory capacity become available. Individuals can easily carry the electronic apparatus. A ubiquitous society where anyone can access required information anywhere at any time is now emerging.

In such an information society, there is no question about the importance of security technology for protecting information relating to personal privacy, corporate secret, etc. from unauthorized use.

With an authentication technique available in one of security fields, a user is permitted to use an electronic apparatus if it is authenticated that the user is an authorized user of the electronic apparatus.

Authentication technique using a password is used in a wide range of electronic apparatuses including information processing apparatuses.

Biometric authentication technique, such as fingerprint matching, is phased into practice.

Jpn Pat Publication No. 2000-293688 discloses a technique relating to improvements in the connection, the operation, and the portability of a printed-circuit type fingerprint matching device and a mobile information processing apparatus.

Many authentication techniques for use in the electronic apparatus, such as the information processing apparatus, have been developed. If an authentication process fails, the process of a particular software program may be disabled, the initiation of a particular software program may be inhibited, or the power of the electronic apparatus may be turned off. In this way, information is protected from being disclosed to or retrieved by a third party.

The problem of known authentication techniques is that the security hole (weakness in security) is not completely controlled.

One of the reasons why the security hole is not completely controlled is that an operation panel of each electronic apparatus is exposed to the outside. With the operation panel exposed to the outside, an ill-intentional third party is enabled to manipulate the operational panel.

When an authentication attempt fails, an ordinary user cannot restore the electronic apparatus to a normal operational state by performing a standard operation.

However, if an operation panel is operated in accordance with a predetermined procedure, the user can access an internal software program, and can modify the internal software program by manipulating the electronic apparatus alone or by connecting an external device to the electronic apparatus.

Since the access procedure and the software modification procedure require particular knowledge and technique, ordinary users have difficulty with modifying the software program. However, if one of an access procedure and a software modification procedure is made available by using the operation panel or by connecting an external device to the electronic apparatus, the possibility of modification of the software program cannot be completely excluded as long as the operation panel is exposed from the electronic apparatus.

The modification of the internal software program can cause a pre-registered fingerprint to always match an input fingerprint. The authentication technique is thus invalidated.

The exposed operation panel of the electronic apparatus is thus one of the security holes.

In accordance with one of the techniques disclosed in Jpn Pat Publication No. 2000-293688, a fingerprint input screen is arranged on a cover of an information processing apparatus and a lock arranged between the cover and the main unit of the information processing apparatus is released when fingerprints match each other. In accordance with the disclosure, a fingerprint matching device is mounted on the cover of the information processing apparatus rather than on a PC card. The disclosed technique is intended not to lock the cover to the main unit to prevent an operation panel from being exposed to the outside but to eliminate the need for carrying the PC card.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are external views of an electronic apparatus in accordance with a first embodiment of the present invention;

FIG. 2 illustrates the system configuration of the electronic apparatus in accordance with the first embodiment of the present invention;

FIG. 3 is a state transition diagram of the electronic apparatus in accordance with the first embodiment of the present invention;

FIG. 4 is a flowchart of a security reinforcement method of the electronic apparatus in accordance with the first embodiment of the present invention;

FIGS. 5A and 5B are external views of an electronic apparatus in accordance with a second embodiment of the present invention;

FIG. 6 is a state transition diagram of the electronic apparatus in accordance with the second embodiment of the present invention;

FIG. 7 is a flowchart of a security reinforcement method of the electronic apparatus in accordance with the second embodiment of the present invention; and

FIGS. 8A and 8B are external views of an electronic apparatus in accordance with a third embodiment of the present invention.

### DETAILED DESCRIPTION

An electronic apparatus 1 and a security reinforcement method of the electronic apparatus 1 of embodiments of the present invention are described below with reference to the accompanying drawings.

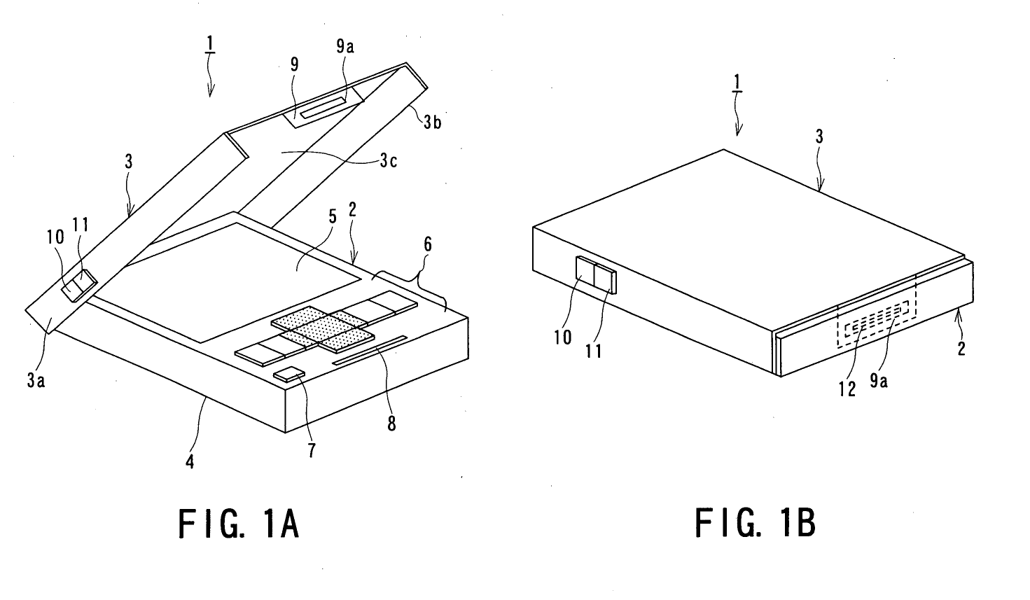

FIGS. 1A and 1B are perspective views of the electronic apparatus 1 in accordance with a first embodiment of the present invention. The electronic apparatus 1 includes, but is not limited to, a compact mobile terminal called personal digital assistant (PDA). The electronic apparatus 1 includes a main unit 2 and a cover 3.

FIG. 1A illustrates the cover 3 in the open state thereof, and FIG. 1B illustrates the cover 3 in the closed state thereof.

As shown in FIG. 1A, the cover 3 of the electronic apparatus 1 is connected to the main unit 2 in a manner such that the cover 3 is pivotally openable about a hinge structure (not shown) of the main unit 2.

The main unit 2 includes components, such as a CPU 20, in a box-like casing 4. Arranged on the casing 4 are a liquid-crystal display 5 for displaying information, operation keys (operation panel) 6 for inputting a variety of operational signals to the electronic apparatus 1, and a power switch 7 for turning on and off the power of the electronic apparatus 1.

A slot 8 receiving a latch 9 extending from the front portion of the cover 3 is arranged in the front portion of the casing 4.

The cover 3 is integrally formed of a top plate portion 3c, a left-side plate portion 3a, and a right-side plate portion 3b. An authentication switch 10 (switch) and a fingerprint sensor 11 (input unit for inputting bio-information) are arranged on the left-side plate portion 3a.

The latch 9 having a latch hole 9a is extended from the top plate portion 3c on the front portion of the cover 3. When the cover 3 is closed, the latch 9 is inserted into the slot 8 of the main unit 2.

As shown in FIG. 1B, a lock mechanism 12 of the main unit 2 is engaged with the latch hole 9a when the latch 9 is inserted into the slot 8. The lock mechanism 12 thus locks the cover 3 to the main unit 2.

With the cover 3 closed, the liquid-crystal display 5, the operation keys 6 and the power switch 7 in the main unit 2 are all covered with the cover 3. The operation keys 6 and the power switch 7 from the outside cannot be accessed from the outside. The material of the cover 3 is not limited to any particular material. From the standpoint of security, the cover 3 is preferably made of a light and robust metal.

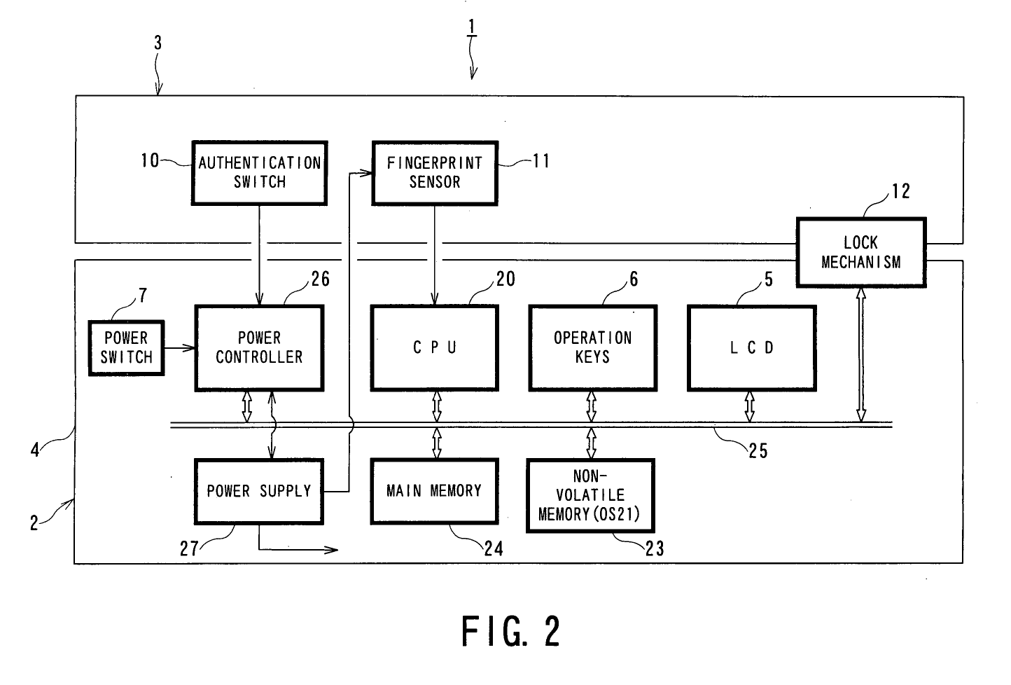

FIG. 2 illustrates the system configuration of the electronic apparatus 1.

The main unit 2 housed in the casing 4 includes the CPU 20 for controlling a variety of processes and the entire system, a non-volatile memory 23 for storing an OS (operating system) 21 executed by the CPU 20, a variety of application programs 22, and a variety of data, a main memory 24 for temporarily storing a variety of data processed by the CPU 20, and a bus 25 for interconnecting these elements.

Also connected to the bus 25 are the operation keys 6 for inputting a variety of operational signals to the electronic apparatus 1, the liquid-crystal display 5 for displaying a variety of information, a power controller 26 for controlling a main power system, and the lock mechanism 12 for locking and unlocking the cover 3 to and from the casing 4, respectively.

The power switch 7 arranged in the main unit 2 is connected to the power controller 26. The main unit 2 contains a power supply 27. The power supply 27 feeds power to the elements in the main unit 2 and the fingerprint sensor 11 mounted on the cover 3.

The cover 3 includes the authentication switch 10 and the fingerprint sensor 11. An output from the authentication switch 10 is supplied to the power controller 26.

An output from the fingerprint sensor 11 is supplied to the CPU 20 in the main unit 2.

The operation of the electronic apparatus 1 thus constructed is described below with reference to FIGS. 1A and 1B through FIG. 3.

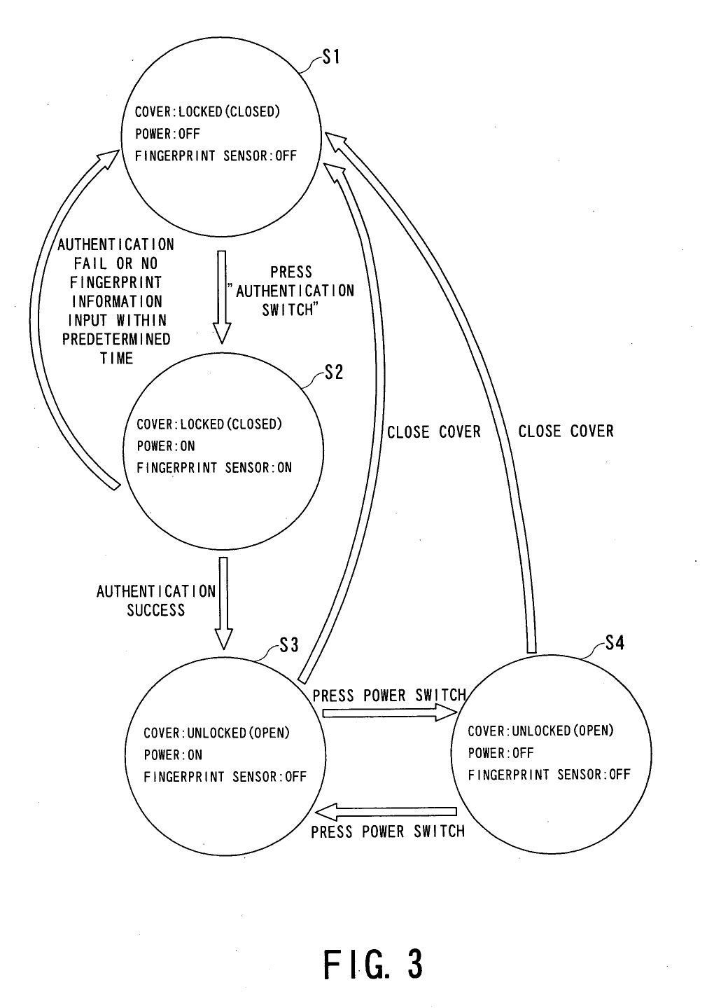

FIG. 3 is a state transition diagram of the electronic apparatus 1. The electronic apparatus 1 has four states, i.e., an initial state S1, an authentication state S2, a standard operation state S3, and an open-cover and off state S4.

In the initial state S1, the cover 3 is closed with the lock mechanism 12 locking the cover 3 to the casing 4, and both the main unit 2 and the fingerprint sensor 11 are powered off. The initial state S1 means an inoperative state in which the user does not operate the electronic apparatus 1.

Since the cover 3 is closed and locked to the casing 4 in the initial state S1, the user accessible elements are limited to the authentication switch 10 and the fingerprint sensor 11 arranged on the cover 3.

When the user presses the authentication switch 10, the electronic apparatus 1 transitions to the authentication state S2. In the authentication state S2, both the main unit 2 and the fingerprint sensor 11 are powered on, but the cover 3 remains locked to the casing 4 with the lock mechanism 12.

A transition operation from the initial state S1 to the authentication state S2 is described below.

When the user presses the authentication switch 10 down, a press signal is transferred to the power controller 26 in the main unit 2 (see FIG. 2). Since the power consumption of the power controller 26 is minimal, only the power controller 26 is continuously fed with power even when the electronic apparatus 1 is powered off. As a result, the power controller 26 recognizes the press signal from the authentication switch 10 even when the electronic apparatus 1 is powered off.

Upon receiving the process signal, the power controller 26 outputs a control signal to the power supply 27 in the main unit 2. In response to the control signal, the power supply 27 feeds power to each of the elements in the main unit 2 and the fingerprint sensor 11 on the cover 3.

That state is a state immediately subsequent to the completion of the transition from the initial state S1 to the authentication state S2. The cover 3 still remains locked to the casing 4.

In the authentication state S2, the electronic apparatus 1 operates as described below.

In the authentication state S2, the fingerprint sensor 11 is ready to read fingerprint information because the fingerprint sensor 11 is powered on.

The main unit 2 is also powered on. With the elements in the main unit 2 powered, the OS 21 stored in the non-volatile memory 23 is initiated. The OS 21 controls the entire system. The CPU 20 operates under the control of the OS 21.

With a finger pressed on the fingerprint sensor 11, the CPU 20 receives fingerprint information from the fingerprint sensor 11 in accordance with a software program stored in the non-volatile memory 23. The CPU 20 compares fingerprint information stored (registered) beforehand in the non-volatile memory 23 with the fingerprint information input from the fingerprint sensor 11.

If the two pieces of fingerprint information match each other, the authentication process is successfully completed. If the two pieces of fingerprint information do not match each other, the authentication process fails. An authentication unit performing the authentication process based on authentication information input from the fingerprint sensor 11 (input unit) includes the CPU 20 for executing the software program stored in the non-volatile memory 23 and the fingerprint information stored in the non-volatile memory 23. The process up until now is performed in the authentication state S2.

If the authentication process has been successfully completed, the electronic apparatus 1 is transitioned from the authentication state S2 to the standard operation state S3.

In the standard operation state S3, the cover 3 is unlocked from the casing 4, and the main unit 2 is powered on while the fingerprint sensor 11 is powered off.

A transition operation to the standard operation state S3 is initiated in response to an unlock command output from the CPU 20 to the lock mechanism 12. Upon receiving the unlock command from the CPU 20, the lock mechanism 12 unlocks the latch 9 in the cover 3 from the casing 4. As a result, the user can open the cover 3.

To transition to the standard operation state S3, the CPU 20 commands the power controller 26 to power off the fingerprint sensor 11. The power controller 26 controls the power supply 27 to switch off only power to the fingerprint sensor 11.

In the standard operation state S3, the main unit 2 is powered on with the OS 21 operative. Since the cover 3 is unlocked from the casing 4, the user can normally operate the electronic apparatus 1. Since the fingerprint sensor 11 has completed the authentication process, switching off the fingerprint sensor 11 saves power.

If the authentication process has failed in the authentication state S2, the electronic apparatus 1 returns from the authentication state S2 to the initial state S1. More specifically, the CPU 20 under the control of the OS 21 performs a predetermined sequence, thereby commanding the power controller 26 to stopping the supplying of power to the fingerprint sensor 11 and the elements in the main unit 2. Furthermore, if no fingerprint information has been input for a predetermined period of time or more, the electronic apparatus 1 also returns from the authentication state S2 to the initial state S1.

As described above, the unlocking of the lock mechanism 12 subsequent to the successful authentication process and the on and off operation of power to the main unit 2 and the fingerprint sensor 11 (input unit) are performed by a control unit configured mainly by the CPU 20 and the power controller 26.

The user ends the standard operation by simply closing the cover 3. In other words, the closing operation of the cover 3 causes the electronic apparatus 1 to transition from the standard operation state S3 to the initial state S1.

Many of the mobile information terminals, such as the PDAs, are provided with an automatic power-off function. In the automatic power-off function, the mobile information terminal is automatically powered off if the user does not operate the terminal for a predetermined period of time or longer. In the electronic apparatus 1 having the automatic power-off function, if the user closes the cover 3, the cover 3 is locked to the casing 4 and both the main unit 2 and the fingerprint sensor 11 are automatically powered off after a predetermined period of time.

If the power switch 7 is pressed with the cover 3 opened, power is off, and the electronic apparatus 1 is transitioned from the standard operation state S3 to the open-cover and off state S4. If the cover 3 is closed in the open-cover and off state S4, the electronic apparatus 1 is returned to the initial state S1.

If the power switch 7 is pressed again in the open-cover and off state S4, power is on, and the electronic apparatus 1 resumes the standard operation state S3.

In the electronic apparatus 1 of the first embodiment of the present invention in the initial state S1 or in the case of the failure in the authentication process, the operation keys 6 are covered with the cover 3, and the cover 3 is continuously locked to the casing 4 in the main unit 2.

Even if a third party attempts to attack the security hole by operating the operation keys 6, the operation keys 6 cannot be accessed. The attempt to attack the security hole thus fails. Even if an ill-intentional third party has the knowledge about the software modification procedure to invalidate the access procedure to the software and the authentication mechanism, the physical access to the operation keys 6 is difficult. The authentication mechanism thus cannot be invalidated.

A high level of security is thus achieved in comparison with the known electronic apparatuses that permit access to operational keys.

The electronic apparatus 1 of the first embodiment of the present invention with the fingerprint authentication mechanism does not need a key operation such as entering a password. Even with the cover 3 covering the operation keys 6, the authentication information can be entered by the compact fingerprint sensor 11. An authorized user achieves a high level of security with the cover 3 covering the operation keys 6 while still enjoying excellent operability.

With the authentication switch 10 arranged at a location accessible from the outside, the fingerprint sensor 11 is powered on only during the initiation of the authentication process. This arrangement eliminates the need for continuously powering the fingerprint sensor 11, and thus power saving is achieved.

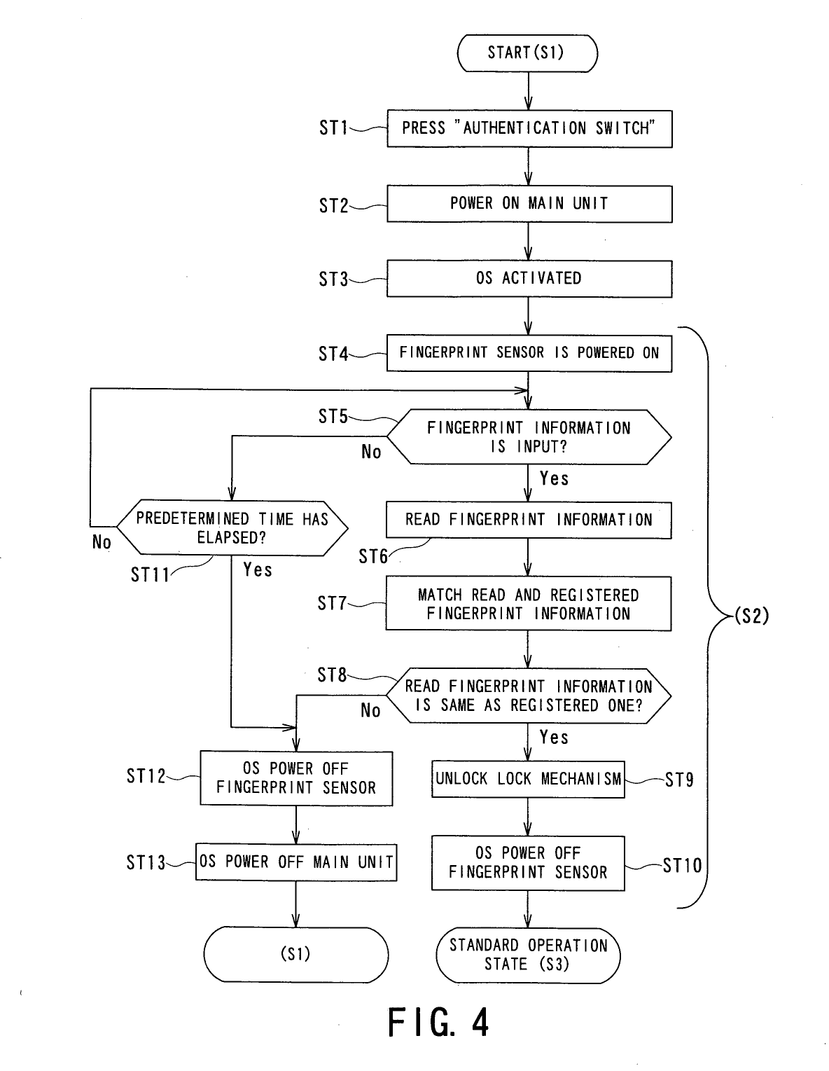

FIG. 4 illustrates the process of the security reinforcement method of the electronic apparatus 1 of the first embodiment of the present invention.

In a first step, the cover 3 is locked to the casing 4 in the main unit 2, and both the main unit 2 and the fingerprint sensor 11 are powered off. The first step corresponds to the initial state S1 of FIG. 3.

In a second step, the authentication information is input. More specifically, the authentication switch 10 is pressed (step ST1). In response to the pressing of the authentication switch 10, the electronic apparatus 1 is powered on (step ST2). The OS 21 is activated (step ST3).

Under the control of the OS 21, the fingerprint sensor 11 is fed with power (step ST4). The CPU 20 determines whether the fingerprint information has been input from the fingerprint sensor 11 (step ST5). The fingerprint information received from the fingerprint sensor 11 is then read (step ST6).

In a third step, the read fingerprint information is matched against the registered fingerprint information (step ST7). The CPU 20 thus determines whether the read fingerprint information matches the registered fingerprint information (step ST8).

In a fourth step, the lock mechanism 12 for locking the cover 3 to the casing 4 is unlocked (step ST9) if the read fingerprint information matches the registered fingerprint information. The fingerprint sensor 11 is then powered off (step ST10), and the electronic apparatus 1 is shifted to the standard operation state S3. Step ST4 through step ST10 of FIG. 4 correspond to the authentication state S2 of FIG. 3.

If a predetermined period of time has elapsed without receiving the fingerprint information (yes in step ST11), or if the received fingerprint information fails to match the registered fingerprint information (no in step ST8), the OS 21 switches off the fingerprint sensor 11 (step ST12) and then switches off the elements in the main unit 2 (step ST13), and returns to the initial state S.

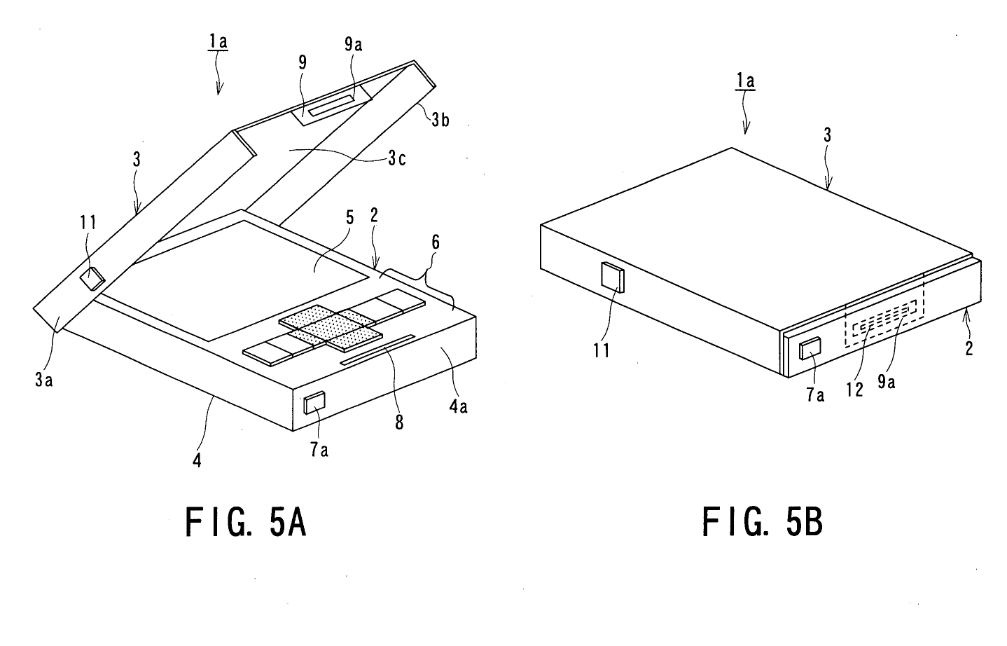

FIG. 5 is an external view of an electronic apparatus la in accordance with a second embodiment of the present invention.

The electronic apparatus 1a of the second embodiment of the present invention includes a power and authentication switch 7a, into which the authentication switch 10 and the power switch 7 of the electronic apparatus 1 of the first embodiment are integrated. The rest of the second embodiment remains unchanged from the first embodiment.

The integrated power and authentication switch 7a is arranged on a location accessible from the outside with the cover 3 closed, for example, on a front plate portion of the casing 4 as shown in FIG. 5.

The power and authentication switch 7a, if pressed, conveys a contact signal to the power controller 26. Unlike the operation keys 6, the power and authentication switch 7a is not related to the accessing to and the modification of the software program. Even if the power and authentication switch 7a is not covered with the cover 3, no problem is presented on security.

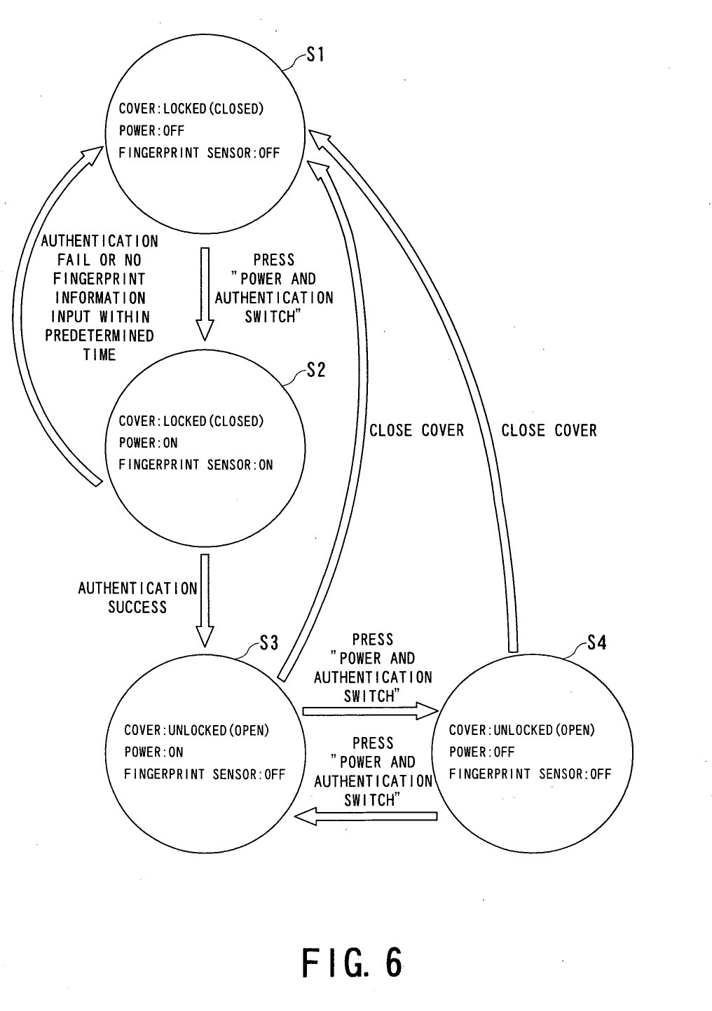

FIG. 6 is a state transition diagram of the electronic apparatus la of the second embodiment of the present invention. The difference of the second embodiment in the state transition diagram from the first embodiment is that the electronic apparatus la is transitioned from the initial state S1 to the authentication state S2 in response to the pressing of the power and authentication switch 7a instead of the authentication switch 10.

The transition operation between the standard operation state S3 and the open-cover and off state S4 is also performed by pressing the power and authentication switch 7a.

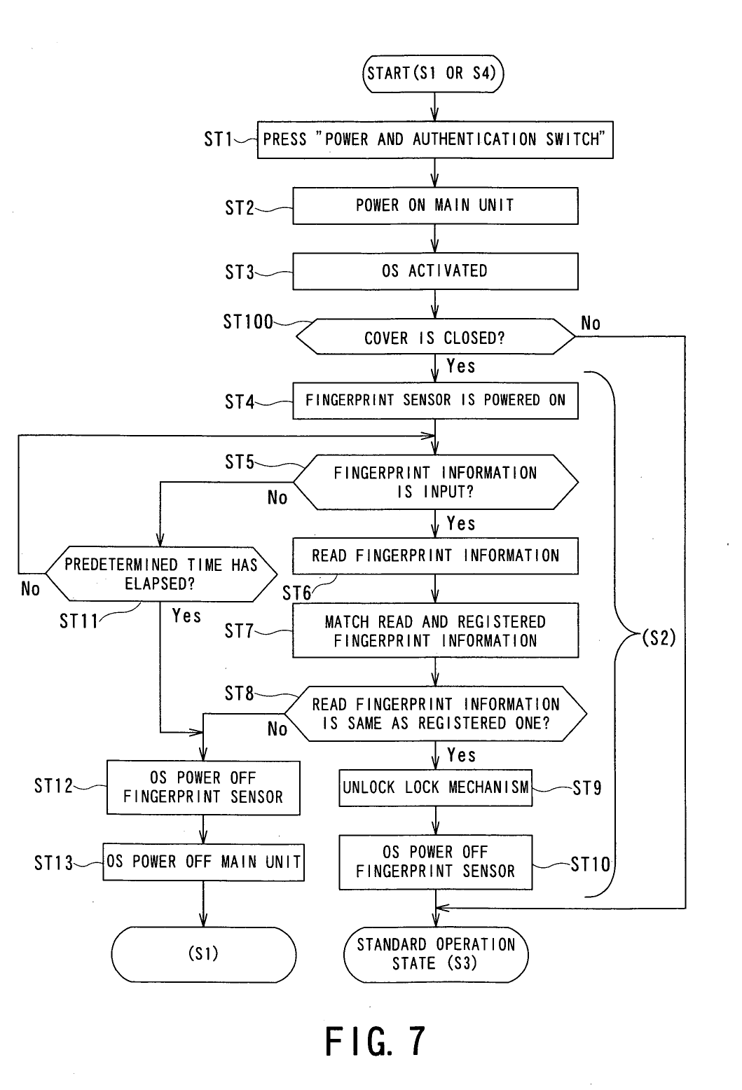

FIG. 7 illustrates the process flow of the electronic apparatus la of the second embodiment of the present invention.

Each of the electronic apparatus 1 of the first embodiment and the electronic apparatus la of the second embodiment has two states, namely, the initial state S1 and the open-cover and off state S4, in which both power and the fingerprint sensor 11 are off.

In accordance with the first embodiment, the electronic apparatus 1 is transitioned from the initial state S1 to the authentication state S2 in response to the pressing of the authentication switch 10.

In accordance with the second embodiment, the authentication switch 10 and the power switch 7 are integrated into the power and authentication switch 7a. For this reason, the status of the cover 3 needs to be monitored to determine whether the transition responsive to the pressing of the power and authentication switch 7a is from the initial state S1 or the open-cover and off state S4.

In accordance with the second embodiment, step ST100 is included to determine the status of the cover 3.

If the cover 3 is closed when the power and authentication switch 7a is pressed, the transition is determined as being from the initial state S1 to the authentication state S2. If the cover 3 is opened, the transition is determined as being from the open-cover and off state S4, and the electronic apparatus 1 is transitioned to the standard operation state S3.

The rest of the operation of the second embodiment is substantially identical to the first embodiment. In accordance with the second embodiment, the electronic apparatus la employs the power and authentication switch 7a, into which the authentication switch 10 and the power switch 7 of the first embodiment are integrated. The number of components is thus reduced, leading to cost reduction and light-weight design. Even if the switches are integrated in this way, the same security level is maintained.

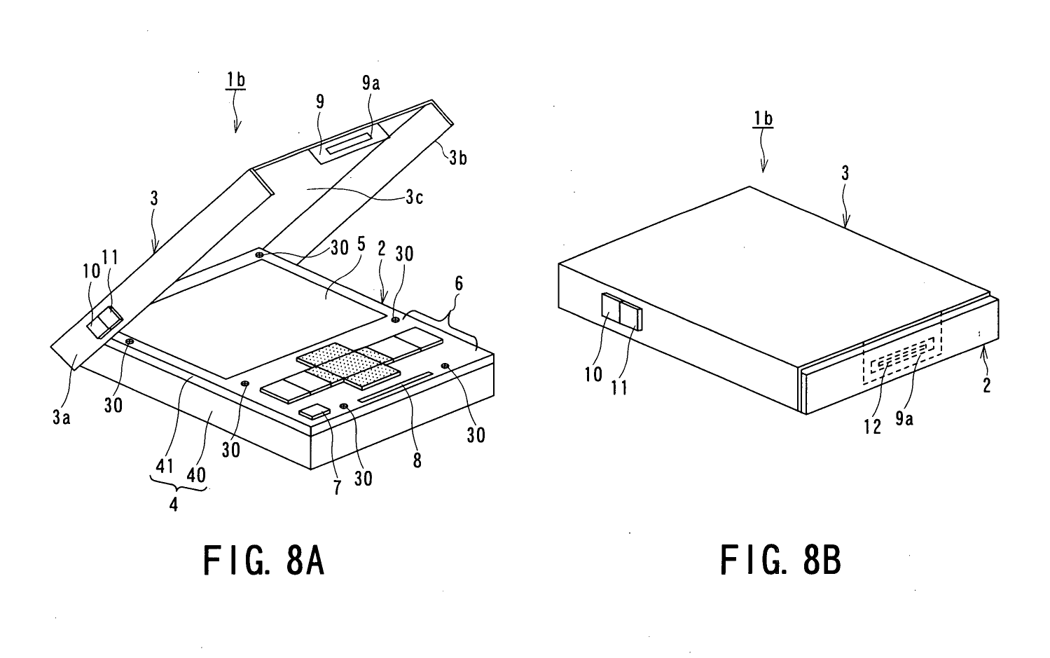

FIGS. 8A and 8B are external views of an electronic apparatus 1b in accordance with a third embodiment of the present invention.

In the electronic apparatus 1b of the third embodiment, the casing 4 includes a box-like casing 40 having an opening on the top portion thereof, and a lid plate 41 covering the opening of the casing 40.

To assemble the electronic apparatus 1b, the lid plate 41 is placed to cover the opening of the casing 40 after the elements in the main unit 2 are installed into the casing 40 via the opening thereof. The lid plate 41 is then fixed to the casing 40 using a plurality of fixing screws 30 (fixing unit).

The casing 40 has a unitary structure. To gain access to the elements in the main unit 2 housed in the casing 40, there is no other means but removing the fixing screws 30 to open the lid plate 41.

With the cover 3 above the lid plate 41 closed, it is difficult to gain access to the fixing screws 30. In this state, it is difficult to take out or gain access to the elements in the main unit 2 housed in the casing 4.

With the cover 3 locked to the casing 4 in the electronic apparatus 1b of the third embodiment of the present invention, it is difficult to take out or gain access to the elements in the main unit 2 housed in the casing 4. This arrangement prevents an illegal action. For example, it will be almost impossible to connect an external device to the non-volatile memory 23 in the main unit 2 to read information stored therein.

The electronic apparatus 1b of the third embodiment enhances security level even higher than the security level achieved by the first embodiment.

The present invention is not limited to the above-described embodiments. Modification and change are possible without departing the scope of the present invention. The above-referenced embodiments are combined in a variety of forms. Several elements can be removed from each of the above-reference embodiments, and elements from the different embodiments can be combined.

What is claimed is:

1. An electronic apparatus comprising:
a main unit;
a cover, openably attached to the main unit, which covers an operation unit arranged in the main unit;
a lock mechanism which locks the cover to the main unit with the cover closed to the main unit;
an input unit configured to input bio-information to the main unit with the cover closed to the main unit;
an authentication unit which performs an authentication process in response to inputting the bio-information by the input unit; and
a control unit configured to release the lock mechanism from the lock state thereof to unlock the cover from the main unit when the authentication process is succeeded.

2. The electronic apparatus according to claim 1, wherein the bio-information comprises fingerprint information.

3. The electronic apparatus according to claim 1, further comprising
a switch which is operative with the cover closed to the main unit, and
a power control unit which powers on the electronic apparatus when the switch is operated with the cover closed to the main unit, and powers off the input unit in succession to the releasing of the lock mechanism when the authentication process is succeeded, or powers off the electronic apparatus with the cover closed to the main unit when the authentication process is failed.

4. The electronic apparatus according to claim 1, wherein the main unit comprises:
a box-like casing which has an opening portion on one surface thereof;
a lid plate which closes the opening;
fixing unit which fixes the lid plate to the main unit, and
wherein the cover covers the fixing unit.

5. The electronic apparatus according to claim 3, wherein the switch comprises a power switch arranged in the electronic apparatus.

6. A method of reinforcing security of an electronic apparatus comprising a main unit and a cover, openably attached to the main unit of the electronic apparatus, which covers an operation unit arranged in the main unit, the method comprising:
locking the cover to the main unit with a lock mechanism with the cover closed to the main unit;
inputting bio-information with the cover closed to the main unit;
performing an authentication process based on the input bio-information; and
releasing the lock mechanism when the authentication process is succeeded.

7. The method according to claim 6, wherein the bio-information comprises fingerprint information.

8. The method according to claim 6, further comprising powering on the electronic apparatus, after the locking the cover to the main unit, when a switch, included in the electronic apparatus and operative with the cover closed to the main unit, is pressed with the cover closed to the main unit, and
after the performing the authentication process, powering off an input unit for inputting the bio-information in succession to the releasing of the lock mechanism when the authentication process is succeeded, or
powering off the electronic apparatus with the cover closed to the main unit when the authentication process is failed.

9. The method according to claim 6, wherein the main unit comprises:
a box-like casing which has an opening portion on one surface thereof;
a lid plate which closes the opening;
fixing unit which fixes the lid plate to the main unit; and
wherein the locking the cover to the main unit includes covering the fixing unit by the cover.

10. The method according to claim 8, wherein the switch comprises a power switch arranged in the electronic apparatus.
